(19) United States
(12) Patent Application Publication
(10) Pub. No.: US 2004/0197762 A1
(43) Pub. Date: Oct. 7, 2004

(54) Sports training apparatus and methodology

(76) Inventor: Jay C. Peters, Tahoe City, CA (US)

Correspondence Address: John D. Long, PO Box 3444, Reno, NV, 89509, US

(21) Appl. No.: 10/406,839

(22) Filed: Apr. 3, 2003

(51) Int. Cl. G09B 19/00; G09B 25/00

(52) U.S. Cl. 434/383

(57) ABSTRACT

This invention is a methodology and apparatus for sports maneuver instruction and development comprised of a scaled miniature poseable figurine of human representation that is reversibly attached to a similarly scaled miniature of a sports implement. The figure has poseable arms legs and torso that will retain the pose set by the user until changed by the user into a different pose. The methodology for using the figure as an instructional and visual aid includes having the user holding the figure, pose and position the figure in the initial pose of a position in a sports maneuver. The user then reposes and repositions the figure as necessary to “act out” each step or a particular step the maneuver that the user was interested in. In this manner, the user, could visually teach novice sports enthusiasts, or use the figure individually to analyze known sports maneuvers or to create new ones.

### CROSS-REFERENCES TO RELATED APPLICATIONS

Not Applicable.

### STATEMENT REGARDING FEDERALLY SPONSORED RESEARCH OR DEVELOPMENT

Not Applicable

### REFERENCE TO A “MICROFICHE APPENDIX”

Not Applicable.

### BACKGROUND

1. Field of the Invention

The present invention relates to the field of the models and the usage of models to aid in the instruction and training of sports and other activities.

2. Description of the Related Art

The inclusion of snowboarding in the Winter Olympic events shows the dramatic rise and worldwide acceptance of snowboarding as a winter sport and recreational pastime over the past two decades. This is especially true, since the sport now has its in nationally televised championships.

The attractive characteristic of this sport are the maneuvers, stunts and acrobatics that its participants perform on their snowboards while traveling down on the snow slopes or specially prepared downhill courses. In many instances, the snowboarders intentionally become airborne with the snowboard and perform various controlled acrobatics before landing on the snowboard to continue downhill and perform other such maneuvers. Many of the snowboard maneuvers are named after their originators who have acquired considerable fame in this sport because of these tricks they have designed.

The increase in the popularity of the sport has been accompanied by a rapid increase in complexity and difficulty of the sports maneuvers, stunts and acrobatics performed by the participants on their snowboards. For example, where a few years ago performing a “360” degree turn (rotation) with a snowboard was the outer plane of snowboard operation, snow boarders are now performing “1440” (four rotations or turns). In light of these developments, new participants of the sport want to learn established maneuvers, while more experienced snowboarders, armed with advances in snowboard technology and a strive to push the thrill envelope of the snowboard maneuvering capability, want to develop new, more thrilling and complex snowboard stunts, maneuvers, and acrobatics.

Snowboarders and participants of other sports therefore have a need for a methodology and apparatus through which they can learn, communicate, teach and develop various sports maneuvers, stunts and acrobatics.

Currently, there is such a technology as described in the U.S. Pat. No. 6,614,327 to Wittenbecher on Jul. 9, 2002. Wittenbecher sets forth a device for training a specified course of movement for a person by the manipulation of a corresponding object. Movement sensors are placed on the person of the trainee as well as any object utilized by the trainee in the sport. The data processor monitors the movement of the trainee/object and informs the trainee of the optimal and preferred movement during the specific movement involved.

U.S. patent issued to Neuberg et al, U.S. Pat. No. 5,536,225 on Jul. 16, 1996 mechanically simulates skiing condition so that the user can exercise as well as train.

Air force pilots and personnel, particularly those who are connected with the flying of fighter aircraft and related combat aerobatics, handle and move the pointers with aircraft representations on their tips to show how the actual aircraft would maneuver in a particular situation. Instructors would utilize the pointers to visualize how the trainees should maneuver their aircraft in combat or when performing other aerial movements.

Similarly, the U.S. Pat. No. Des 323,007 issued to Chantey on Jan. 7, 1992 discloses a design for a finger-held training device for instruction of snowboard maneuvering. The design shows a snowboard with detachable finger straps into which the user presumably inserts its fingers to manipulate the miniature snowboard. However, this design is limited as to communication, developing or demonstrating modern day snow boarding capabilities in that the physical manipulation of user's fingers are not capable of demonstrating a complete turn (“360”) of the snowboarder, the most basic of snowboard aerial maneuvers, much less the 1440 rotations practiced today.

The above-described art does have further limitations in their practical application for instruction and development of snowboard maneuvers. The art utilizing computer data processing and tactile sensors, and those using large mechanical machinery by its own design does not lend itself to individual or personal use because such art is more directed to institutionalized use. Further, the complexity of the patented invention would have a direct correlation to a relatively high expense of obtaining and operating such devices along with training necessary to run them.

The aircraft pointer type snowboard designs are limited in that they also can not be moved to represent the full movement of the user, in this case the snow boarder, as she executes the maneuver.

Therefore what is needed is an apparatus and methodology for sports instruction and maneuver development which is non-complex, inexpensive, of simple manufacture and can be used without the need for extensive training or directions.

### SUMMARY OF THE INVENTION

This invention is a simple and cost effective methodology and apparatus for sports instruction and maneuver development comprised of a handheld scaled poseable figurine of a snowboarder that is reversibly attached to a similarly scaled miniature of a snowboard.

The figure has poseable arms legs and torso that will retain the pose set by the user until changed by the user into a different pose. To enhance the realism of the figure, it has the scaled appearance of a snowboarder, preferably the likeness of a well-known or famous snowboard athlete. The figure's external appearance also will include the representation of the clothing typical of the fashion of the sport.

The methodology for using the figure as an instructional and visual aid include having the user holding the figure, pose and position the figure in the initial pose that a real snowboarder would obtain in relation to the snow when starting the maneuver. The user then re-pose and repositions the figure as necessary to “act out” each step of the maneuver or a particular step or series of steps in which the user was interested. In this manner, the user, as an snowboard instructor, could visually teach novice snowboarders, or use the figure by himself to analyze and learn known snowboard maneuvers or to create new snowboard maneuvers.

It is another object of the invention to be of simple design and affordable.

It is still another object of the invention to facilitate the instruction of novice snowboarders.

It is still another object of the invention to facilitate the analysis, learning and creation of sports maneuvers.

It is still another object of the invention to help prevent injuries from sports activities by utilizing a means and apparatus for learning and analyzing sports movement without first having the user actually engage in such maneuvers.

It is still a further object of the invention to recognize difficulties in sports maneuvers and help develop solutions to such difficulties.

### DESCRIPTION OF THE DRAWINGS

FIG. 1 A front, back, right side and left side elevation drawings of the invention

FIG. 2 Perspective elevation of the sports implement

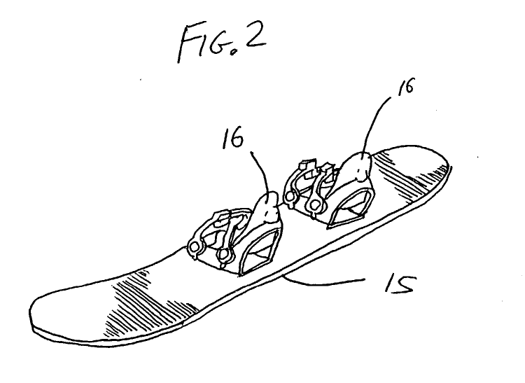

FIG. 3 A perspective drawing of the invention being held near representation of a snowboard tunnel

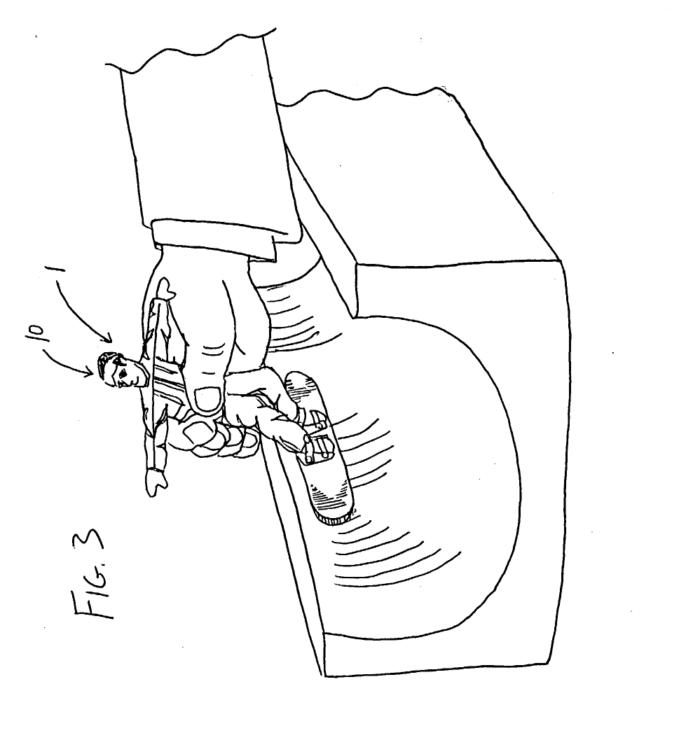

### DESCRIPTION OF THE NUMERICAL LISTING

1 invention

10 figure

11 head

12 arm

13 leg

14 torso

15 snowboard

16 bootbindings

### DETAILED DESCRIPTION OF THE PREFERRED EMBODIMENTS

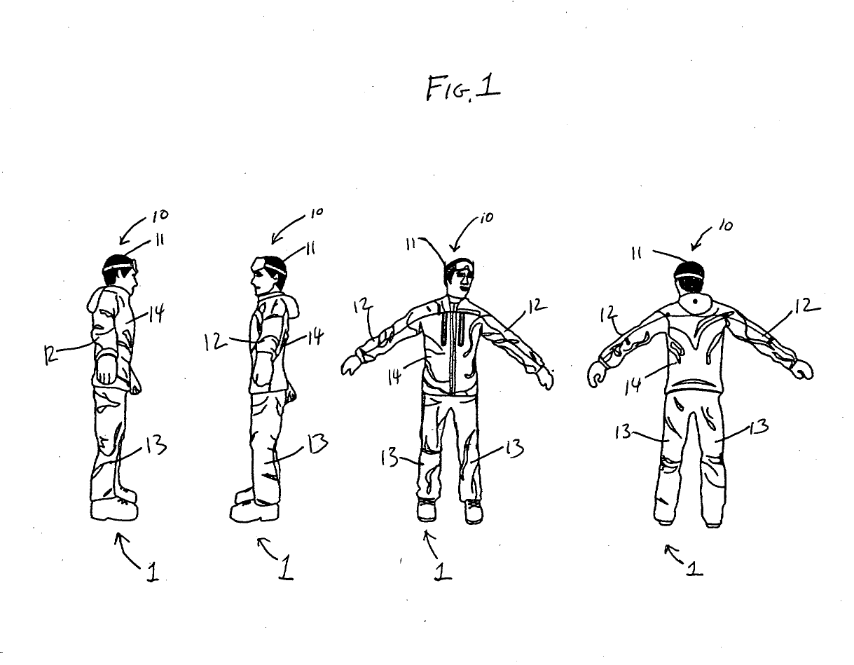

As shown in FIG. 1, the present invention, generally denoted by numeral 1 is an apparatus and methodology for teaching, analyzing and creating maneuvers used in sports and other activities. The invention 1 comprises a figure, generally denoted by numeral 10, which is a poseable handheld three-dimensional scaled representation of an athlete, sports accessories and sports implement. In the preferred embodiment, the FIG. 10 is a snowboarder with detachable snowboard as the sports implement, preferably demonstrating a correctly scaled and proportioned human figurine rather than a toy-like or cartoonish depiction. The FIG. 10 would have a reversible attached sports implement, in the present case, a snowboard 15. In other embodiments of the invention depicting other sports, the sport implement would be freestyle downhill skis, wake board, roller blades, skate boarding, body surfing board, surf board, and the like. The sports accessories can be additional articles of clothing, like a backpack; safety equipment such as a helmet; goggles and such

The FIG. 10 can encompass the recognizable likeness of a well-known and accomplished athlete of the depicted sport who utilizing the clothing and other relevant accessories that are used in the depicted sport. This use of a well-known entity of the sport to which the FIG. 10 pertains, would aid in learning sports maneuvers by helping to inspire the user when using the FIG. 10, to move towards the level of sports excellence embodied by goodwill of the depicted well-known athlete. The FIG. 10, in addition to being correctly portioned and detailed, will feature appropriate coloration in its depiction.

The FIG. 10, in accurately personifying a human representation, will feature a solid bendable body having a head 11, torso 12, arms 13 and legs 14. The FIG. 10 will be made from a pliable polyelastomer which allows torso 12, arms 13, and legs 14 to be positioned by the user in a wide variety of poses that mimic the sports movements of a participant or the athlete in the depicted sport. The arms will feature hands in an open position so that the hands can reversibly grab and hold by friction-fit the sports accessories.

To provide the ability of the FIG. 10 to hold the pose set by the user until changed by the user at a later time, flexible wires are laid and secured within the longitudinal midsections of the torso 12, arms 13 and legs 14 during the manufacturing process of the FIG. 10. The wires are flexible enough to be easily bent into a position of the portion of the body set by the user, yet resilient enough to oppose the natural tendency of the polyelastomer body to make the body assume the position into which it was originally manufactured.

Another embodiment of the figure is a multiple-piece articulated action figure such as GI Joe® of the Hasbro Toy Company, whose type of construction is well known to those versed in the art. Such figures are made to scale at various sizes and feature articulated joined limbs, head and torso and in some cases, digits of the appendages such as the hand.

The snowboard 15 has two bootbindings 16 that are scaled down versions of the real sized bootbindings. The bootbindings 16 would be made from several components constructed from resilient but flexible polyelastomer. Each boot binding is pivotally attached to the snowboard by rivet allowing movement of the bootbindings 16 that aids in the attachment of the feet of the FIG. 10 to the snowboard 15. Each bootbinding 16 has one or more removable straps which when attached to the bootbinding 16, reversibly secures the foot of the FIG. 10 in the bootbinding 16.

The snowboard 15 would also be made from polyelastomer and would be appropriately colored and feature popular graphics associated with the full-sized snowboards 15.

The FIGS. 10 can also come with separate accessories such as protective clothing, safety helmet and goggles and the like and are reversibly affixed to the FIG. 10 by friction and or elastic force. In this manner, a beginner to the sport can also begin to learn and understand about the equipment and accessories that are used in the sport.

In an alternative embodiment of the invention 1, the figure could be representative of a downhill skier. The FIG. 10 would be accompanied by skis and other snow ski paraphernalia such as ski poles with handles. The skis would each feature a peg that is reversibly accepted by a corresponding cavity in the bottom of the figure's foot so that the ski would be attached by friction fit to the skier figure. The figure's hand would be able to reversibly grasp the handles of the ski pole. In this manner, the figure would be used to show the proper relationship of the ski poles to the skis and FIG. 10 during the sports maneuver.

While the preferred embodiment as shown is a snowboarder figure, the FIGS. 10, the sports implements and the accessories can be derived from players and equipment of any sport where movement analysis, training and learning is utilized. Other such examples could include surfers, skate boarders, ice skaters and the like.

Additionally, the FIG. 10, sports implement, accessories, while being operated by the user, could be held and used in relation to a depicted ground surface representing the actual terrain that the depicted sports figure would operate on. In this manner, the user could hold and move the FIG. 10 in relation to the depicted ground surface of a modeled terrain of a portion of a free style down hill ski slope and show how the sports figure would launch herself off of a mogul to commence a maneuver. Similarly, a FIG. 10 depicting snow boarder could be used in conjunction with a representation of a snowboard halfpipe (a slope with a U-shaped cross section).

As a demonstrative and teaching aid, the FIG. 10 would be posed by an instructor of the sport to depict a sport's participant in the beginning of a sports maneuver, and in the present case, a snowboarder who is about to go down a slope. The instructor would then pose or position the FIG. 10 in a initial stance or position of a sports maneuver then moving and re-posing/repositioning the FIG. 10 in a subsequent stance or pose of the sports maneuver while simultaneously explaining to the students each position, stance or pose of the sports maneuver so depicted.

In preferred embodiment, the snowboarder instructor would show the students, via the FIG. 10, how a snowboarder has to ride the side edge of the snowboard to maintain her control and direction while descending down a slope; how the snowboarder has to zigzag down the slope; how the snowboarder has to change the balance of her body when she changes the riding side of snowboard when she goes from a zig to a zag and visa versa; and how to apply pressure to the board edge to change direction. During this explanation, the snowboard instructor also changes the initial pose by bending the torso and arms of the FIG. 10 into subsequent poses/positions to indicate correct stances for the snowboarder during this maneuver.

A more experienced sports enthusiast would pose and manipulate the FIG. 10 by herself in order to analyze or dissect each event of a sports maneuver that she wished to perform. In this manner, the more experienced sports enthusiast could carefully examine the maneuver, and then affix to her memory each successive movement of the sports maneuver necessary to successfully complete the sports movement.

While these descriptions directly describe the above embodiments, it is understood that those skilled in the art may conceive modifications and/or variations to the specific embodiments shown and described herein. Any such modifications or variations that fall within the purview of this description are intended to be included therein as well. It is understood that the description herein is intended to be illustrative only and is not intended to be limitative.

1) a model for analyzing, teaching, developing sport maneuvers comprising of:
A hand-held three dimensional poseable figure with sports implement, depicting a human representation having a body comprised of a head, legs, arms, that are connected to and movable in relation to a torso, the exterior of the figure representing a likeness of an athlete in sports attire;
a depicted ground surface;
wherein the figure with the sports implement is held by a user and posed in a position of a sports maneuver in relation to the depicted ground surface for the purpose of instructing at least one third party on the sports maneuver.

2-10. (Canceled)

11) A method for analyzing, teaching, and developing sport maneuvers utilizing a hand-held three dimensional poseable figure with sports implements and accessories, the figure depicting a human representation having a body comprised of a head, legs, arms, that are movably connected in relation to a torso, the exterior of the figure representing a likeness of an athlete, comprised of the steps:
a) grasping the figure by the user,
b) attaching the sports implement to the figure,
c) positioning the arms and legs in to an initial pose representative of a position of a sports maneuver, and
d) repositioning the arms and legs to a subsequent pose representative of a subsequent position of a sports maneuver;
e) moving the figure relative to a depicted ground surface; and
f) issuing instructions by the user to a third party regarding at least one sports maneuver.

12-17 (Canceled)
